(19) United States
(12) Patent Application Publication
(10) Pub. No.: US 2014/0122699 A1
(43) Pub. Date: May 1, 2014

(54) AUTO-UPDATE OF UPDATES AND APPLICATIONS IN A DISTRIBUTED M2M SYSTEM

(71) Applicants: Robbin Hughes, Plano, TX (US); Ramesh Rajasekaran, Chennai (IN); Thomas John O'Neill, La Jolla, CA (US); Prem Jothipragasam Kumar, San Diego, CA (US)

(72) Inventors: Robbin Hughes, Plano, TX (US); Ramesh Rajasekaran, Chennai (IN); Thomas John O'Neill, La Jolla, CA (US); Prem Jothipragasam Kumar, San Diego, CA (US)

(21) Appl. No.: 13/666,847

(22) Filed: Nov. 1, 2012

(51) Int. Cl. G06F 15/173

(52) U.S. Cl. 709/224

(57) ABSTRACT

The embodiments herein relate to Machine to Machine (M2M) based systems and, more particularly, to updating of applications and services in M2M based systems. The embodiments herein disclose a system and method for automatically updating applications and services in a distributed wireless M2M system and the transport mechanism for implementing the updates. Embodiments disclosed herein enable performing updates in Sensors, while accounting for the absence of any one good link to the Sensor, despite spotty coverage, low bandwidth, and frequent retransmissions. Embodiments herein provides for much less cumbersome and time-consuming manual intervention by the user to maintain updated application software. Embodiments herein also reduces the chance of errors leading to a device being made non-functional in the system. Embodiments herein also leads to greater availability of the network itself, as less time is consumed updating sensors and concentrator hubs and also leads to quickest rollout and usage of new functionality.

### TECHNICAL FIELD

The embodiments herein relate to Machine to Machine (M2M) based systems and, more particularly, to updating of applications and services in M2M based systems.

### BACKGROUND

Machine to Machine (M2M) systems comprise of an interconnected web of devices, wherein the devices use wired and/or wireless based communication networks to communicate with each other. The system may be a one to one system, wherein one device communicates with only one other device at a time. The device may also be a one to many system, wherein one device may communicate with multiple devices at the same time. The M2M system may be a centralized system, wherein the devices communicate via a centralized hub, wherein the hub performs analysis on data received from devices, before forwarding the data and/or analysis to the other devices. The M2M system may also be a peer to peer system, wherein the devices communicate to each other directly; wherein analysis may be performed at the source device or the destination device(s).

Even in a M2M system, the devices require updates, wherein the updates may be purely software, hardware or a combination of software and hardware updates. For instance in a distributed M2M system, the sensors and concentrator hubs may need to have their scaling apps and transport data formatting updated to add functionality or improve performance.

Currently, updating of devices in a M2M system involves the devices being updated manually, wherein the device is taken offline (i.e., it is disconnected from the communication networks) for performing the updates. The devices may also be updated by over-the-air downloading of the updates via the communication network.

The above mentioned methods are cumbersome, are time consuming and require manual intervention by the user of the device. The chances of errors during the updating process are also high and this may lead to the device being non-functional for longer periods within the system. The availability of the network is reduced and may lead to a delayed roll out and usage of new functionalities in the devices. Further, the updating process requires continuous network connectivity, with the updating process being error prone and time consuming, if the network has spotty coverage, low bandwidth and is required to do frequent retransmissions.

### BRIEF DESCRIPTION OF THE FIGURES

The embodiments herein will be better understood from the following detailed description with reference to the drawings, in which:

FIG. 1 is a diagram of a M2M system, as disclosed in the embodiments herein; and

FIG. 2 is a block diagram of a M2M platform, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

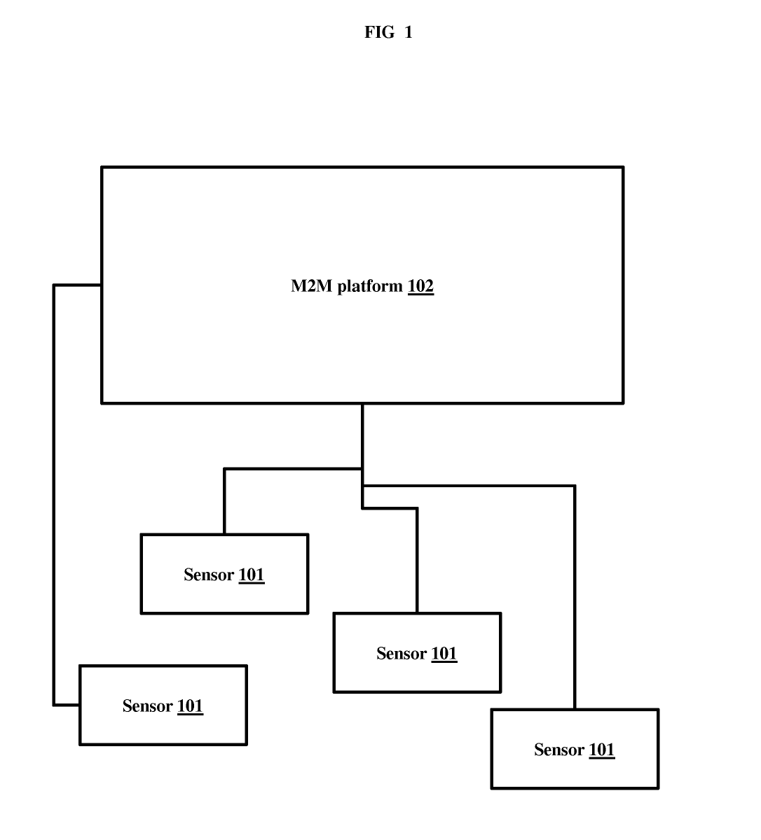

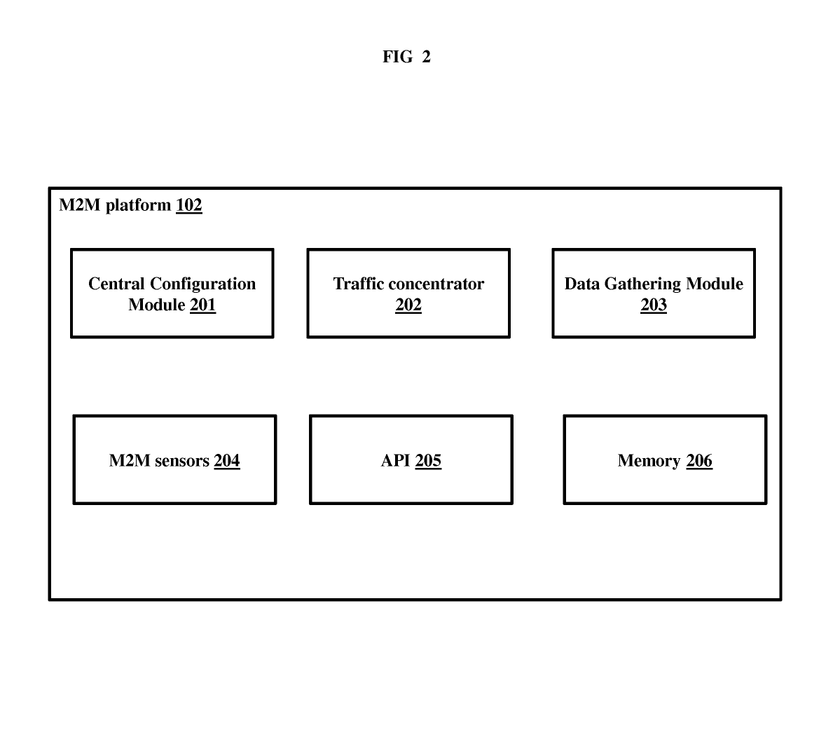

The embodiments herein disclose a system and method for automatically updating applications and services in a distributed wireless M2M system and the transport mechanism for implementing the updates. Referring now to the drawings, and more particularly to FIGS. 1 through 2, where similar reference characters denote corresponding features consistently throughout the figures, there are shown embodiments.

FIG. 1 is a diagram of a M2M system, as disclosed in the embodiments herein. The M2M system comprises of a plurality of sensors 101 connected to a M2M platform 102. The sensors 101 may be any device capable of communicating with at least one external device. The sensor 101 may be any device configured to communicate with at least one external device using an external module connected to the sensor 101 using a suitable means, wherein the suitable means may be a USB port, VGA port, a mini USB port, a micro USB port and so on. In another embodiment herein, the sensor 101 may be configured to connect to communicate with at least one external device using an internal module present within the sensor 101. Examples of the sensor 101 are but not restricted to refrigerators, television sets, microwaves, computers, mobile phones, phones, PDAs, tablets, ovens, washing machines and so on. The sensor 101 may communicate with the M2M platform 102 using any suitable communication means such as a cellular technology based communication network, a Wi-Fi network, a Bluetooth network, a Near Field Communication (NFC) based network, a ZigBee based network and so on.

The M2M platform 102 measures various parameters of backhaul links as well as the short-range links to the sensors 101. The parameters may comprise of link bandwidth, latency, jitter, signal strength, packet and/or frame error rate. Based on the parameters and the nature of the updates, the M2M platform 102 makes decisions related to the updates and performs actions on the basis of the decisions. The actions may be related to the updates, in terms of how the updates are to be transmitted (in terms of the optimum routing, if the updates need to be split into smaller sizes, sizes of the split files, deciding to wait for the links to improve and so on) and applied. The M2M platform 102 further monitors the status of the updates. The M2M platform 102 further monitors the versioning throughout the sensors 101 and the M2M platform 102. The M2M platform 102 further provides a means to view the update status of each of the sensors 101 and their respective versioning information.

FIG. 2 is a block diagram of a M2M platform, as disclosed in the embodiments herein. The M2M platform 102, as depicted, comprises of a central configuration module 201, a traffic concentrator module 202, a data gathering module 203, a plurality of M2M sensors 204, a plurality of APIs 205 and a memory 206.

The central configuration module 201 is configured for measures various aspects of backhaul links as well as the short-range links to the sensors 101. Based on the quality of the links and the nature of the updates to be performed on the sensors 101, the central configuration module 201 makes decisions related to the updates and performs actions on the basis of the decisions.

The traffic concentrator module 202 is configured for receiving update information payload and commands to receive an update, and to report status, back to the central office.

The central office configuration module 201 is further capable of evaluating the versioning throughout the M2M network and acting on the basis of the evaluations.

The central office configuration module 201 is further configured for automatically downloading updates into the sensors 101, holding these updates in the memory 206, and restarting the sensors 101 to accept and run the new update.

The central office configuration module 201 further provides a display of current device update status and versioning for a network operator, wherein the network operator may connect to the M2M platform 202 using the API 205.

The M2M sensors 204 comprise of a plurality of sensors using cellular technology, Wi-Fi, Bluetooth, Near Field Communication (NFC), ZigBee and so on.

The data gathering module 203 fetches data related to the sensors 101 and the related updates and stores the data in the memory 206.

Embodiments disclosed herein enable performing updates in sensors, while accounting for the absence of any one good link to the sensor, despite spotty coverage, low bandwidth, and frequent retransmissions.

Embodiments herein provides for much less cumbersome and time-consuming manual intervention by the user to maintain updated application software. Embodiments herein also reduces the chance of errors leading to a device being made non-functional in the system. Embodiments herein also leads to greater availability of the network itself, as less time is consumed updating sensors and concentrator hubs and also leads to quickest rollout and usage of new functionality.

The embodiments disclosed herein can be implemented through at least one software program running on at least one hardware device and performing network management functions to control the network elements. The network elements shown in FIG. 2 include blocks, which can be at least one of a hardware device, or a combination of hardware device and software module.

The embodiment disclosed herein specifies a system and method for automatically updating applications and services in a distributed wireless M2M system and the transport mechanism for implementing the updates. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device, which can be programmed including e.g. any kind of computer like a server or a personal computer, or the like, or any combination thereof, e.g. one processor and two FPGAs. The device may also include means, which could be e.g. hardware means like e.g. an ASIC, or a combination of hardware, and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for updating at least one device in a Machine to Machine (M2M) system, the method comprising of
detecting links between a M2M platform and the at least one device by the M2M platform, on detecting an update for the device;
deciding on an update path based on condition of the links by the M2M platform; and
performing the update of the at least one device by the M2M platform.

2. The method, as claimed in claim 1, wherein the method further comprises of providing status of the update to a network operator.

3. The method, as claimed in claim 1, wherein the method further comprises of monitoring versioning of the at least one device.

4. The method, as claimed in claim 1, wherein the method further comprises of
restarting the at least one device, on performing the update; and
running the update on the at least one device.

5. A Machine to Machine (M2M) system for updating at least one device in the M2M system, the system configured for
detecting links between a M2M platform and the at least one device, on detecting an update for the device;
deciding on an update path based on condition of the links; and
performing the update of the at least one device.

6. The M2M system, as claimed in claim 5, wherein the system is further configured for providing status of the update to a network operator.

7. The M2M system, as claimed in claim 5, wherein the system is further configured for monitoring versioning of the at least one device.

8. The M2M system, as claimed in claim 5, wherein the system is further configured for
restarting the at least one device, on performing the update; and
running the update on the at least one device.
